(19) United States
(12) Patent Application Publication
(10) Pub. No.: US 2024/0019700 A1
(43) Pub. Date: Jan. 18, 2024

(54) Waveguide Based Display Device

(71) Applicant: DigiLens Inc., Sunnyvale, CA (US)

(72) Inventors: Nima Shams, Sunnyvale, CA (US); Alastair John Grant, San Jose, CA (US); Milan Momcilo Popovich, Leicester (GB)

(73) Assignee: DigiLens Inc., Sunnyvale, CA (US)

(21) Appl. No.: 18/252,177

(22) PCT Filed: Nov. 8, 2021
(86) PCT No.: PCT/US21/72287

§ 371 Date: May 8, 2023

Related U.S. Application Data
(60) Provisional application No. 63/110,878, filed on Nov. 6, 2020.

(51) Int. Cl. G02B 27/01; F21V 8/00

(52) U.S. Cl. CPC G02B 27/0172; G02B 6/0016; G02B 6/0035; G02B 2027/0178; G02B 2027/0174; G02B 2027/0112

(57) ABSTRACT

A wearable waveguide display having multiple input projection arrays configured to project an image into a waveguide via separate input couplers and project the image via an output element. The wearable display can be configured in a number of configurations that minimize weight and maximize comfort and resolution of the projected images. In some embodiments, the wearable waveguide display includes a first microLED array which outputs light into a first input coupler and a second microLED array which outputs light into a second input coupler. The first input coupler and the second input coupler both in couple light into total internal reflection in a waveguide. The incoupled light is outcoupled via an output optical element.

### CROSS-REFERENCED APPLICATIONS

The present application claims priority to U.S. Provisional Patent Application No. 63/110,878, entitled “WEARABLE DISPLAYS” and filed on Nov. 6, 2020, the disclosure of which is incorporated herein by reference in its entirety.

### FIELD OF THE INVENTION

The present invention generally relates to waveguide devices and, more specifically, to waveguide devices implemented within a wearable display.

### BACKGROUND

Waveguides can be referred to as structures with the capability of confining and guiding waves (i.e., restricting the spatial region in which waves can propagate). One class of waveguides includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for Augmented Reality (“AR”) and Virtual Reality (“VR”), compact Heads Up Displays (“HUDs”) for aviation and road transport, and sensors for biometric and laser radar (“LIDAR”) applications.

### SUMMARY OF THE INVENTION

Many embodiments are directed to a waveguide display including: a first microLED array emitting a first wavelength image-containing light; a second microLED array emitting a second wavelength image-containing light; a first projection lens for collimating and projecting the first wavelength image-containing light over a field of view; a second projection lens for collimating and projecting the second wavelength image-containing light over a field of view; a waveguide supporting: an output grating configured to provide light extraction from the waveguide; a first input coupler for directing the first wavelength image-containing light into a first TIR path within the waveguide via a first pupil; and a second input coupler for directing the second wavelength image-containing light into a second TIR path within the waveguide via a second pupil.

In many other embodiments, the waveguide is curved.

In still many other embodiments, the waveguide display further includes a third microLED array emitting third wavelength image-containing light; a third projection lens for collimating and projecting the third wavelength image-containing light over a field of view; and a third input coupler for directing the third wavelength image-containing light into a third TIR path within the waveguide via a third pupil.

In still many other embodiments, the first, second, and third wavelengths correspond to red, green, and blue light respectively.

In still many other embodiments, the first, second and third microLEDs are disposed adjacent to each other along the waveguide beam propagation direction.

In still many other embodiments, the waveguide further includes gratings configured to multiply the resolution of the image.

In still many other embodiments, the waveguide display further includes polarization selecting and polarization rotating optical elements disposed in the optical path between each microLED array and the waveguide for converting the light from each microLED array into polarized light.

In still many other embodiments, the waveguide has a substrate curvature providing a spectacle prescription.

In still many other embodiments, the waveguide, the first microLED array, the second microLED array, the first projection lens, and second projection lens are integrated within a spectacle frame.

In still many other embodiments, the waveguide display further includes at least one of: a camera, a LiPo battery, a microphone, a spatial audio module, a radio, a microprocessor, plastic or thixotropic molded magnesium hinges, a heat path sink formed from graphene or aluminum, or carbon fiber components used for RF emission and SAR protection.

In still many other embodiments, the output grating multiplexes a grating for diffracting first wavelength light and a grating for diffracting second wavelength light.

In still many other embodiments, the output grating multiplexes a first grating for diffracting light in first angular range and a second grating for diffracting light in a second angular range.

In still many other embodiments, the output grating performs a beam expansion.

In still many other embodiments, the waveguide display further includes a first fold grating and a second fold grating, where the first fold grating provides a beam expansion in a first direction, where the second fold grating provides a beam expansion in the first direction, where the first direction is orthogonal to the beam expansion direction of the output grating.

In still many other embodiments, the waveguide display further includes a first fold grating for directing first wavelength image-containing light in the first TIR path towards the output grating and a second fold grating for directing second wavelength image-containing light in the second TIR path towards the output grating, where the output grating is configured to direct the first wavelength light and the second wavelength light into a common extraction direction.

In still many other embodiments, the output grating performs both one-dimensional beam expansion and extraction of light from the waveguide.

In still many other embodiments, the first input coupler and the second input coupler each include multiple stacked switchable gratings which input light into two different TIR paths angularly displaced by an angle equivalent to half a pixel of the input image in at least one of horizontal direction or vertical direction.

In still many other embodiments, the output grating includes a passive grating configured to output light from the first TIR path and the second TIR path.

In still many other embodiments, the output light from the first TIR path and the second TIR path, when combined, has double the resolution of the light input into the waveguide in at least one of the horizontal and vertical directions.

In still many other embodiments, at least one of the output grating, the first input grating, or the second input grating comprises a holographic polymer dispersed liquid crystal (“HPDLC”) grating.

In still many other embodiments, at least one of the output grating, the first input grating, or the second input grating includes an evacuated Bragg grating (EBG).

In still many other embodiments, the first input grating is physically spaced apart from the second input grating.

In still many other embodiments, the first projection lens and the second projection lens project light towards separate locations on the waveguide.

In still many other embodiments, the waveguide display further includes switchable gratings configured for output field of view tiling.

In still many other embodiments, the output grating includes a first switchable grating configured to provide extraction of a first field of view portion from the waveguide and a second switchable grating configured to provide extraction of a second field of view portion from the waveguide; the first input coupler includes a third switchable grating for directing the first wavelength image-containing light in the first field of view portion into a TIR path towards the output grating via the first pupil and a fourth switchable grating for directing the first wavelength image-containing light in the second field of view portion into a TIR path towards the output grating via the first pupil; the second input coupler includes a fifth switchable grating for directing the second wavelength image-containing light in the first field of view portion into a TIR path towards the output grating via the second pupil and a sixth switchable grating for directing the second wavelength image-containing light in the second field of view portion into a TIR path towards the output grating via the second pupil; the first switchable grating, the third switchable grating, and the fifth grating are in their diffracting states when a first field of view tile data is displayed on the first microLED array and the second microLED array, and the second switchable grating, fourth switchable grating, and the sixth switchable grating are in their diffracting states when a second field of view tile data is displayed on the first microLED array and the second microLED array.

Many other embodiments are directed to a waveguide display including: a first microLED array emitting a first wavelength image-containing light; a second microLED array emitting a second wavelength image-containing light; a first projection lens for collimating and projecting the first wavelength image-containing light over a field of view; a second projection lens for collimating and projecting the second wavelength image-containing light over a field of view; a waveguide supporting: a first fold grating and a second fold grating configured in a stack or multiplexed in a layer, wherein the first fold grating and second fold grating perform two-dimensional beam expansion and extraction of light from the waveguide; an output grating configured to provide light extraction from the waveguide; a first input coupler for directing the first wavelength image-containing light into a first TIR path within the waveguide via a first pupil; and a second input coupler for directing the second wavelength image-containing light into a second TIR path within the waveguide via a second pupil.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a perspective view of a wearable waveguide display in accordance with an embodiment of the invention.

FIG. 2 conceptually illustrates wearable waveguide displays in a storage device in accordance with an embodiment of the invention.

FIG. 3 conceptually illustrates a wearable waveguide display with a laser imaging system in accordance with an embodiment of the invention.

FIGS. 4A and 4B conceptually illustrates various views of a wearable display in accordance with an embodiment of the invention.

FIGS. 5A through 5D conceptually illustrate various views of a wearable waveguide display with a microLED projection system in accordance with an embodiment of the invention.

FIG. 5E conceptually illustrates a cross sectional view of the waveguide display of FIGS. 5A-5D in accordance with an embodiment of the invention.

FIGS. 6A and 6B conceptually illustrate various views of a waveguide display configuration in accordance with an embodiment of the invention.

FIG. 7 conceptually illustrates the principles of pixel wobulation offset in accordance with an embodiment of the invention.

### DETAILED DESCRIPTION

For the purposes of describing embodiments, some well-known features of optical technology known to those skilled in the art of optical design and visual displays have been omitted or simplified to avoid obscuring the basic principles of the invention. Unless otherwise stated, the term “on-axis” in relation to a ray or a beam direction refers to propagation parallel to an axis normal to the surfaces of the optical components described in relation to the invention. In the following description, the terms light, ray, beam and direction may be used interchangeably and in association with each other to indicate the direction of propagation of light energy along rectilinear trajectories. Parts of the following description will be presented using terminology commonly employed by those skilled in the art of optical design. For illustrative purposes, it is to be understood that the drawings are not drawn to scale unless stated otherwise. For example, the dimensions in certain drawings have been exaggerated.

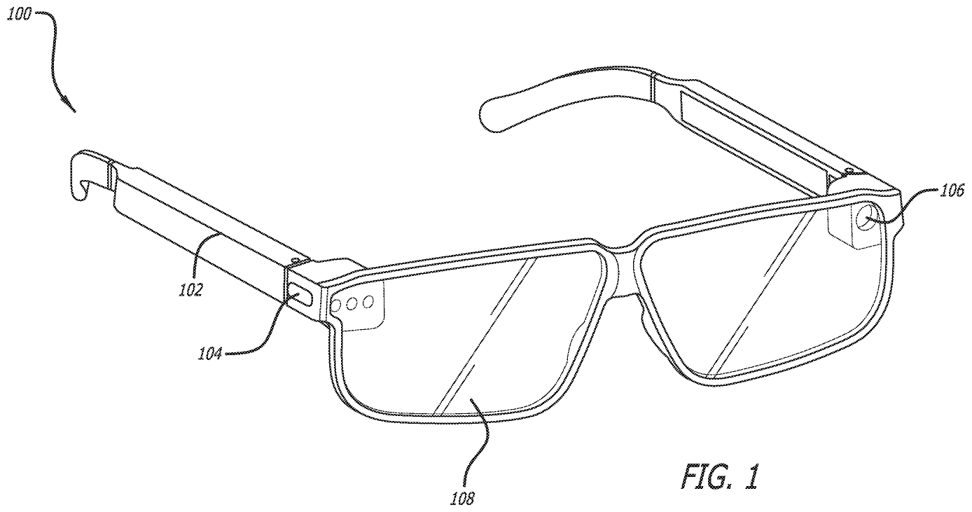

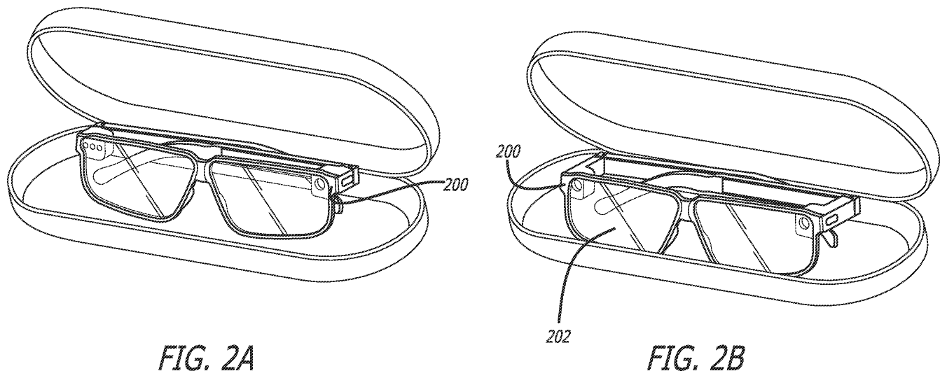

Turning now to the drawings, embodiments of a wearable waveguide display are illustrated. FIG. 1, for example, illustrates a perspective view of a wearable waveguide display 100. The display 100 can be configured to be worn on the face with integrated ear pieces 102. In various embodiments, the ear pieces 102 can be configured to house a number of different elements or components that enable the functionality of the display 100. For example, some embodiments the ear pieces 102 can house the batteries or other electronic components (not shown). In many embodiments, the wearable display 100 can be configured with a camera 104 and an image generation element 106 such as a liquid crystal array or a MEMS array illuminated by an LED, for example, or any other suitable display element. In accordance with many embodiments, the wearable display 100 can be configured with a waveguide display 108 that can display an image to the user. As can be appreciated, many embodiments of a wearable display can be configured to fold or be compacted to fit within a case, as illustrated in FIG. 2. In some embodiments of a wearable display 200, the waveguide display 202 can be configured with a certain refractive profile to correct vision that is integrated with the display elements such that the wearable portion can serve multiple purposes. In some embodiments, the waveguide display 202 may include transition lenses with the ability to change the tint when exposed to bright light. As can be appreciated, the waveguide display 202 can be in an optical glasses frame structure similar to a typical pair of glasses or sunglasses.

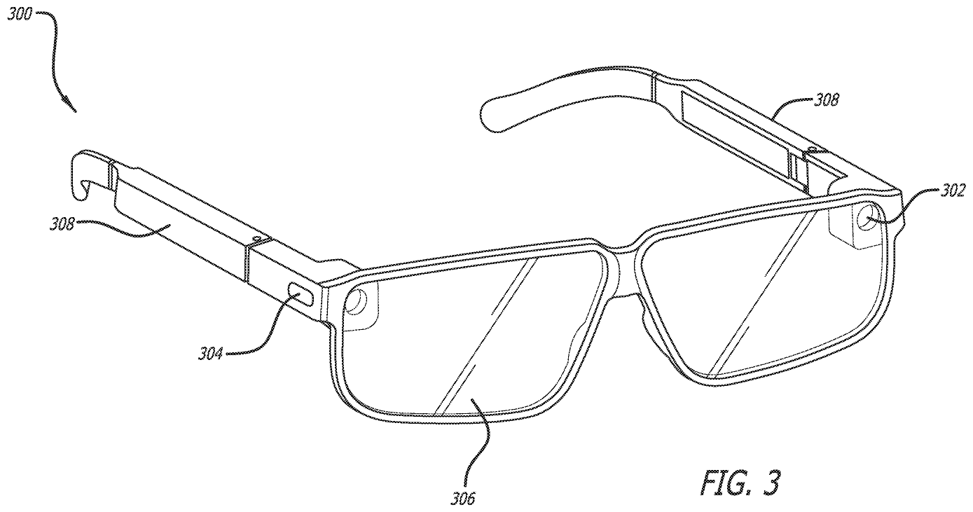

Turning now to FIG. 3, an embodiment of a wearable display is illustrated. In various such embodiments the wearable display 300 may be configured with a camera 302 and an image generation element 304. The image generation element 304 can be any number of suitable imaging devices that can generate an image through a waveguide element 306 that may be displayed to the user. In some embodiments, the image generation element 304 can be a laser projector, for example one based on a laser coupled to a beam scanner and image modulator, the laser projector being optically coupled to the waveguide 306. For example, MEMS devices may be used for scanning the laser beams. Lasers can offer various benefits over alternative platforms for optics, including higher brightness, better color rendition and compact form factor. The wearable display 300 can have other elements disposed within the frame 308, similar to the embodiment illustrated in FIG. 1. Such components can include batteries, audio components, electronic circuit boards, etc.

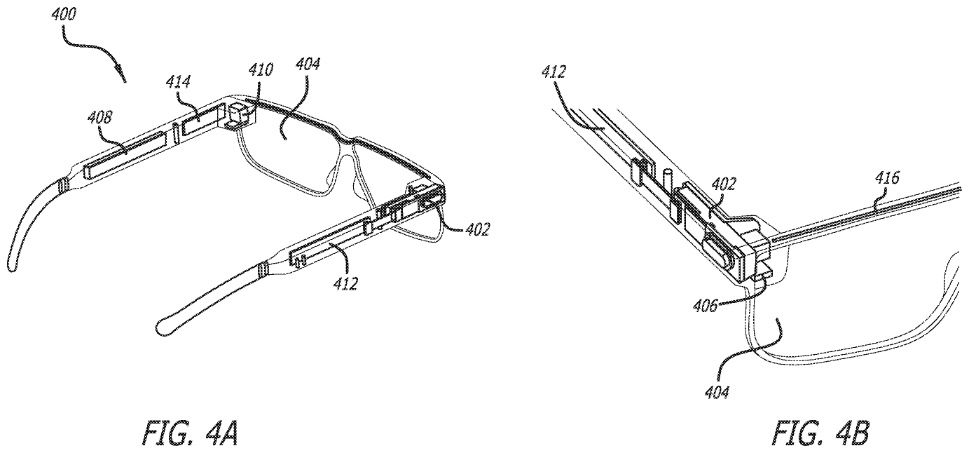

FIGS. 4A and 4B illustrate various views of a waveguide display 400 with the internal component architecture exposed in accordance with an embodiment of the invention. The waveguide display 400 can have a laser projector 402 that is optically coupled to a waveguide 404 through one or more input couplers 406. In some embodiments, the input coupler may be a grating. In some embodiments, the input coupler may be a prism. In some embodiments, the input coupler may combine a grating with a prismatic element. In some embodiments, the input coupler may further comprise apertures, filters, air spaces, mirrors for folding the optical path and polarization components. In some embodiments, a laser projection lens can be positioned between the laser projector 402 and the input couplers 406. The laser projection lens can collimate and project an image over a field of view by projecting the image into the waveguide 404. The input couplers 406 may in couple light from the laser projector 402 into total internal reflection (TIR) paths within the waveguide. In some embodiments, the waveguide 404 can be curved. In various embodiments, the laser projector 402 may incorporate Transparent Resolution Expansion (T-Rex), which is a solid state electrically switchable wobulation solution using switchable gratings to create an angularly shifted version of the input image, where the angular shift corresponds to half a pixel of image displacement, which when combined with the unshifted input image has the effect of doubling the image resolution in at least one of the vertical and horizontal directions. T-Rex gratings can allow for low resolution image generators to provide maximum resolution without adding size, weight, heat, or noise. Wobulation is described within U.S. Pat. App. Pub. No. 2019/0113829, entitled “Systems and Methods for Multiplying the Image Resolution of a Pixelated Display” and filed on Oct. 16, 2018 which is hereby incorporated by reference for all purposes.

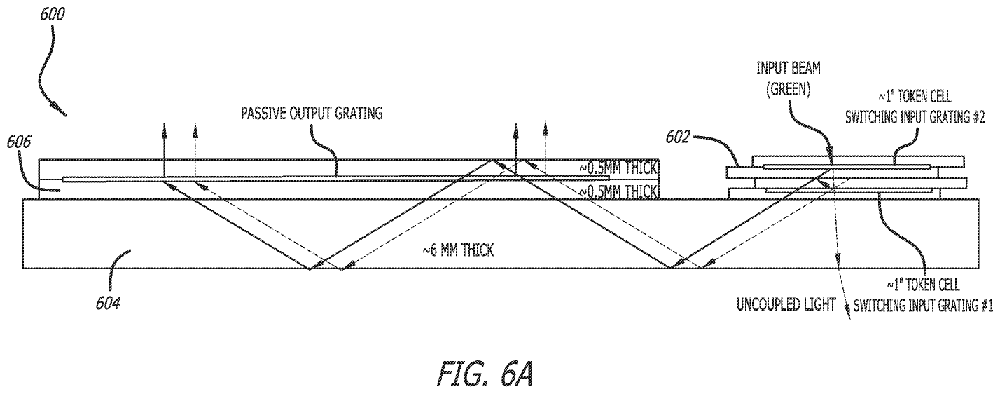

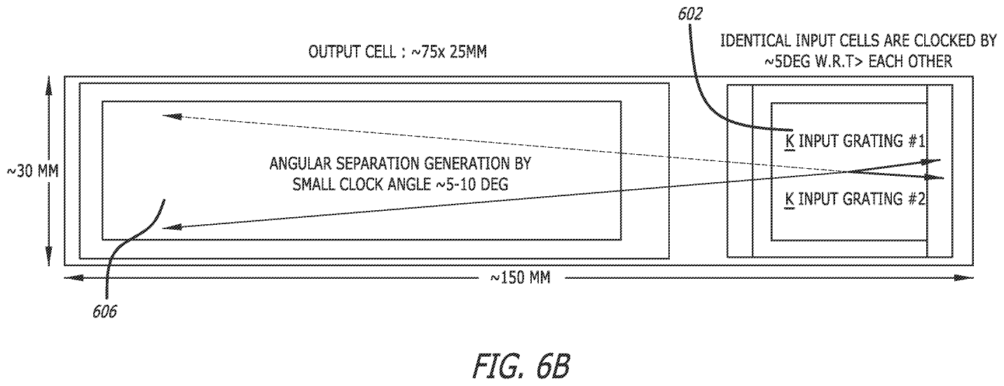

Wobulation may provide resolution multiplication. Wobulation may include a first grating configuration for propagating the originally displayed image and a second grating configuration for provide a version of the input image that is shifted by half a pixel in one or both of the horizontal and vertical direction. The first grating configuration and second grating configuration can be providing by having two input switchable gratings in a stack (as discussed in connection with FIGS. 6A and 6B) and a common non-switchable output grating, the two grating configurations corresponding to a different input grating being switched into its diffracting state while the other input grating is its non-diffracting state. In other examples, wobulation may employ two stacked input gratings and two stack output gratings with all of the gratings being switchable or two or more of the gratings being switchable. In some embodiments, wobulation can be integrated in the projector using vibration of the microdisplay panel vertically and/or horizontally (a technique referred to as “dithering”). However, such schemes may be too noisy and bulky for integrating in glasses, and expensive to implement. Other approaches to wobulation within the projector may use prismatic elements and beam splitting elements to provide the image offset. The resolution-multiplied image can then be collimated and projected using a projection lens. Such solutions may suffer from complexity and bulk and may be uneconomical for most applications. Additionally, many such embodiments may have a battery element 408 electronically connected to a camera 410, the laser projector 402, processors 412, or audio components 414 through internally ran wires or connectors 416.

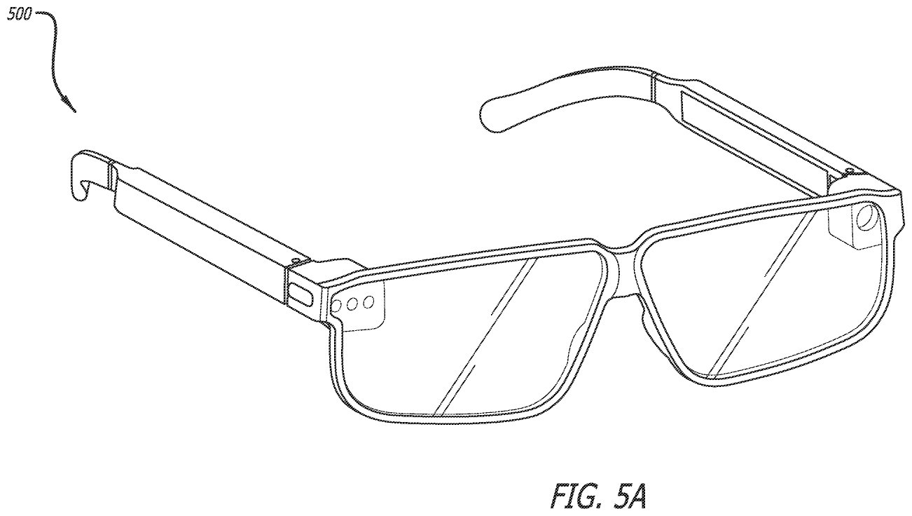

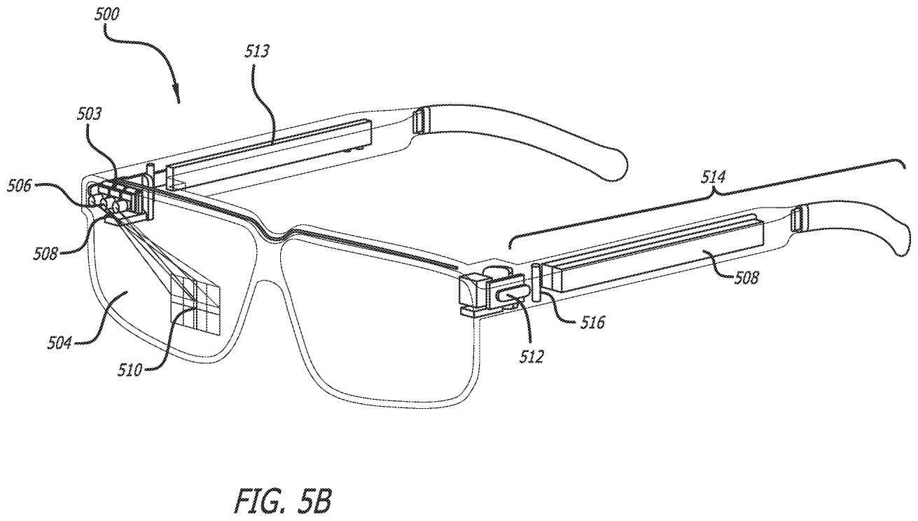

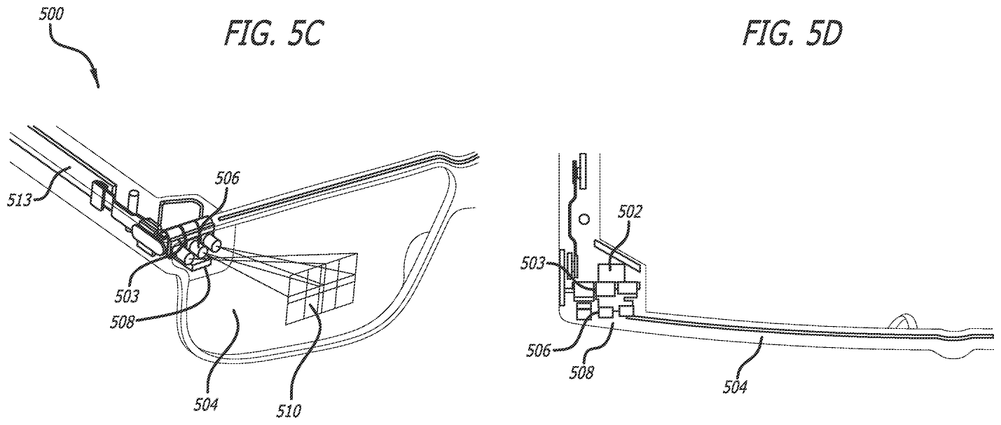

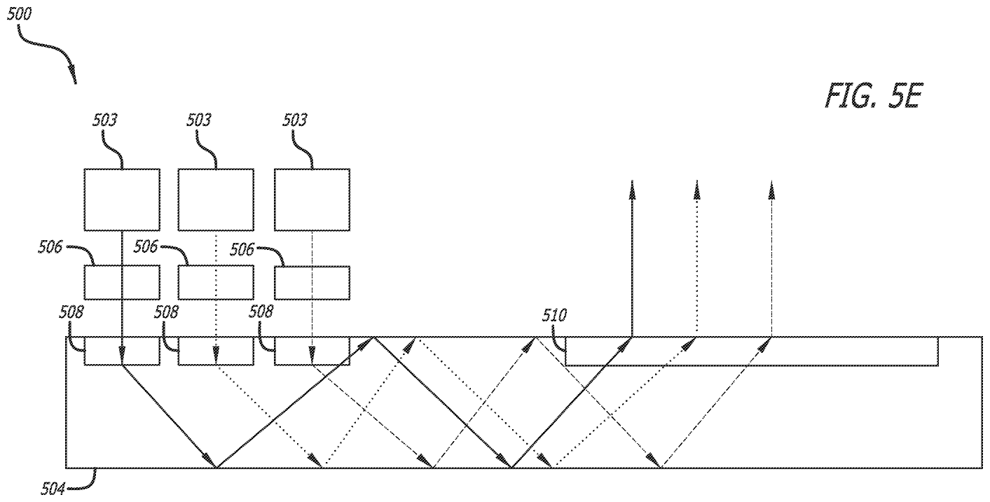

While various embodiments may incorporate laser projectors, many embodiments may use other projectors such as projectors including Red, Green, and Blue (RGB) microLEDs. The microLEDs may be combined with a miniature projection lens. For example, FIGS. 5A through 5D illustrate various views of a wearable waveguide display 500 in accordance with an embodiment of the invention. The waveguide display 500 includes microLEDs 503. The microLEDs 503 may be three microLEDs which output different colors. For example, the microLEDs 503 may include a red microLED, blue microLED, and/or green microLED. The microLEDs 503 may also be two microLEDs which output different colors. For example, there may be one microLED which outputs both red and green light and another which outputs blue light. The microLEDs 503 may output image-containing light. The microLEDs 503 may be connected to electronic circuitry and/or a heat sink 502 located in back of the microLEDs 503. The microLEDs 503 may be optically connected to projection lenses 506. The projection lenses 506 may include different micro-lenses which focus the light into different optical paths. For example, the blue light from the microLEDs 503 may be sent into a different optical path than the green and/or red light from the microLEDs 503. The projection lenses 506 may focus the light coming from the microLEDs 503. The projection lenses 506 can each be associated with a respective microLED to provide light management. Each projection lens may include microlens elements overlaying each pixel of its respective microLED. The projection lenses 506 may improve signal to noise ratio of the light outputted from the microLEDs 503. While the waveguide display 500 has been described with a projector including microLEDs 503, it is understood that various other projection methods have been contemplated as well such as laser beam scanning (LBS), liquid crystal on (LCoS), and digital light processing (DLP).

The projector may include components for converting the unpolarized output of an image source such as a microLED into polarized light matched to the preferred polarization orientation of the waveguide gratings. In some embodiments, the projector may incorporate a polarization selecting optical element and a polarization rotating optical element disposed in the optical path between each microLED 503 and the waveguide 504 for converting the light from each microLED array into polarized light. For example, the projector may incorporate a polarization beam splitter with a halfwave plate in one of the output channels. In some embodiments, the projector may incorporate an array of polarization beams splitters and an array of half wave plates overlapping the output channels of the polarization beam splitters. Various examples of projection systems including polarization conversion systems are discussed in U.S. Pat. No. 6,587,269, entitled “Polarization Recovery System for Projection Displays” and filed Mar. 23, 2001, which is hereby incorporated by reference in its entirety for all purposes. In some embodiments, polarization conversion systems incorporate SBGs. Examples of projection conversions incorporated SBGs are discussed in U.S. Pat. No. 8,634,120, entitled “Apparatus for condensing light from multiple sources using Bragg gratings” and filed Apr. 3, 2009 which is hereby incorporated by reference in its entirety for all purposes. An array-based solution may result in a small form factor. In some embodiments, the projector may include a waveguide integrated laser display (WILD) which is a compact architecture for providing illumination to and projecting image data from a reflective LCoS panel. Features of WILD can include a light source, an illumination waveguide for transmitting light from a laser or LED die towards the LCoS, a grating beam deflector for directing light onto the LCoS and transmitting reflected image-modulated light from the LCoS towards a projection lens which projects the light into a display waveguide via an input coupler. WILD may also include an array of switchable gratings for light homogenization and despeckling (where lasers are used). Further refinements of WILD may include a grating prescription for numerical aperture (NA) management. In some embodiments, NA management (e.g. spatially varying the NA across the input image display) can be used to produce uniform illumination and brightness across the field of view of the final image. In some embodiments, WILD can be implemented for full color using stacked RGB illumination waveguides. A description of WILD is disclosed in U.S. Pat. No. 10,670,876, entitled “Waveguide laser illuminator incorporating a despeckler” and filed on Feb. 8, 2017 which is hereby incorporated by reference in its entirety for all purposes. While a despeckler is described in this patent, this despeckler is not required and there are embodiments described without the despeckler. Further, the projector may include polarization recovery utilizing various films such as a dual brightness enhancement film manufactured by a manufacturer such as 3M Company (incorporated in Minnesota, US).

The projection lenses 506 may focus the light from different optical paths through one or more input couplers 508 located on a waveguide 504. The input couplers 508 may be a combination of prisms and/or gratings. The input couplers 508 can direct the image-containing light from the projection lenses 506 into a TIR path within the waveguide 504 such that a projected image is directed to the pupil of the user. The input couplers 508 may be a plurality of input couplers with each input coupler spaced apart from the other input couplers and configured to receive the light from the projection lenses 506. The light in each optical path may be incoupled through a corresponding incoupler. In some embodiments, the RGB projection beams can be coupled into the waveguide 504 at different locations along the waveguide 504 into different TIR paths. The waveguide may be a curved waveguide. The waveguide 504 further includes output optical element 510. The output optical element 510 may be one or more gratings which is configured to provide beam expansion and light extraction from the waveguide 504. The light inputted through the input couplers 508 into TIR may be outputted through the output optical element 510. The output optical element 510 may receive the light from each TIR path, provide beam expansion to the light, and output the light out of the waveguide 504. The output optical element 504 and the input couplers 508 may be holographic polymer dispersed liquid crystal (HPDLC) gratings such as evacuated Bragg gratings (EBGs). Various HPDLC gratings and EBGs are described in detail in U.S. Pat. App. Pub. No. 2021/0063634 entitled “Evacuating Bragg gratings and methods of manufacturing” and filed on Aug. 28, 2020 which is hereby incorporated by reference in its entirety for all purposes. As with the waveguide display 400 of FIGS. 4A and 5B, the waveguide display 500 may include T-Rex which may include wobulation described above.

Each of the input couplers 508 may be associated with a fold grating which directs the light from the input coupler to its associated output optical element 510. The fold grating may be configured to provide beam expansion in a first direction. The output optical element 510 may provide beam expansion in a direction orthogonal to the first direction. In one example, a first fold grating may direct first wavelength image-modulated light in a first TIR path towards the output optical element 510 and a second fold grating may direct second wavelength image-modulated light in a second TIR path towards the output optical element 510. The output optical element 510 is configured to direct the first wavelength light and the second wavelength light into a common extraction direction. In some embodiments, the output optical element 510 may include separate overlapping monochromatic layers or can multiplex the grating prescription of each monochromatic grating into a single layer.

In some embodiments, two-dimensional beam expansion and extraction may be provided by two overlapping or multiplexed fold gratings eliminating the need for a separate output grating. Such grating architectures are disclosed in U.S. Pat. No. 10,527,797, entitled “WAVEGUIDE GRATING DEVICE” and filed on Nov. 1, 2018, the disclosure of which is incorporated herein by reference in its entirety for all purposes.

In some embodiments, the output optical element 510 may be a multiplexed output grating which may perform beam expansion in the first direction and the second direction. In these embodiments, a fold grating may be absent since the output optical element 510 would perform beam expansion in both the first direction and the second direction. In some embodiments, the output optical element 510 may perform one dimensional beam expansion which may be the only beam expansion performed and thus there is no fold grating.

Additionally, many embodiments may incorporate additional components such as batteries 508, processors 513, audio components 512; all of which can be incorporated into an ear piece 514 of the display. As can be appreciated, many embodiments can have hinges 516 that connect the ear pieces 514 to the waveguide. The hinges 516 can be made of any suitable material or components that can provide sufficient support to the ear piece and waveguide while allowing for ease of movement. For example, some embodiments may use plastic or thixotropic molded magnesium. As can be appreciated, the structural components can be made out of any suitable material that can provide sufficient strength as well as allow for improved functionality of the wearable display. For example, some embodiments may use metallic components, such as aluminum while others utilize plastic and/or carbon fiber. Many embodiments can be manufactured using any combination of materials.

FIG. 5E conceptually illustrates a cross sectional view of the waveguide display 500 of FIGS. 5A-5D. The above description of FIGS. 5A-5D is applicable to FIG. 5E and parts of the description will not be repeated. As discussed above, the waveguide display 500 includes a waveguide 504 which includes a plurality of input couplers 508 and an output optical element 510. A plurality of microLED arrays 503 project image containing light through a plurality of projection lenses 506 into the plurality of input couplers 508 which direct the image containing light into TIR paths. The light is then output through the output optical element 510. The output optical element 510 may perform both beam expansion and light extraction.

FIGS. 6A and 6B conceptually illustrate a waveguide from a waveguide display implementing wobulation to provide enhanced resolution in accordance with various embodiments. The waveguide 600 can be configured with one or more input couplers 602 that are configured to direct an image modulated light into the optical substrate 604 which supports the output optical element 606 through TIR subsequently directing the image modulated light into an output optical element 606 over a particular field of view. The input couplers 602 may be switchable input gratings such as switchable Bragg gratings (SBGs). Various SBGs are discussed in detail in U.S. Pat. No. 8,817,350, entitled “Optical Displays” and filed on Jan. 20, 2021 which is hereby incorporated by reference in its entirety. In accordance with many embodiments, the image modulated light can be inputted into two different optical paths which are illustrated by the separate solid and dashed lines moving through the waveguide 600. The output optical element 606 may be a passive output grating sandwiched by transparent substrates. In some embodiments the output grating may be sandwiched by the substrate 604 and an upper substrate. In some embodiments, the input couplers 602 and output optical element 606 can take on any number of forms, some of which are described later. However, many embodiments can use switchable gratings or passive gratings depending on the desired functionality.

In some embodiments, the waveguide 600 may include switchable gratings configured for output field of view tiling. In some embodiments, the output optical element 606 may include a first switchable grating configured to provide extraction of a first field of view portion from the waveguide and a second switchable grating configured to provide extraction of a second field of view portion from the waveguide. As disclosed in FIGS. 5A-5D, the input coupler 602 may be a plurality of input couplers such as a first input coupler and a second input coupler. The first input coupler may include a third switchable grating for directing the first wavelength image-modulated light in the first field of view portion into a TIR path towards the output grating via a first pupil and a fourth switchable grating for directing the first wavelength image-modulated light in the second field of view portion into a TIR path towards the output grating via a first pupil. The second input coupler may include a fifth switchable grating for directing the second wavelength image-modulated light in the first field of view portion into a TIR path towards the output grating via a second pupil and a sixth switchable grating for directing the second wavelength image-modulated light in the second field of view portion into a TIR path towards the output grating via a second pupil. The first switchable grating, the third switchable grating, and the fifth grating may be in their diffracting states when a first field of view tile data is displayed on the first microLED array and the second microLED array, and the second switchable grating, fourth switchable grating, and the sixth switchable grating are in their diffracting states when a second field of view tile data is displayed on the first microLED array and the second microLED array. Techniques utilizing SBGs for field of view tiling are disclosed throughout U.S. Pat. No. 8,817,350, entitled “Optical Displays” and filed Jan. 20, 2012, which is hereby incorporated by reference in its entirety for all purposes.

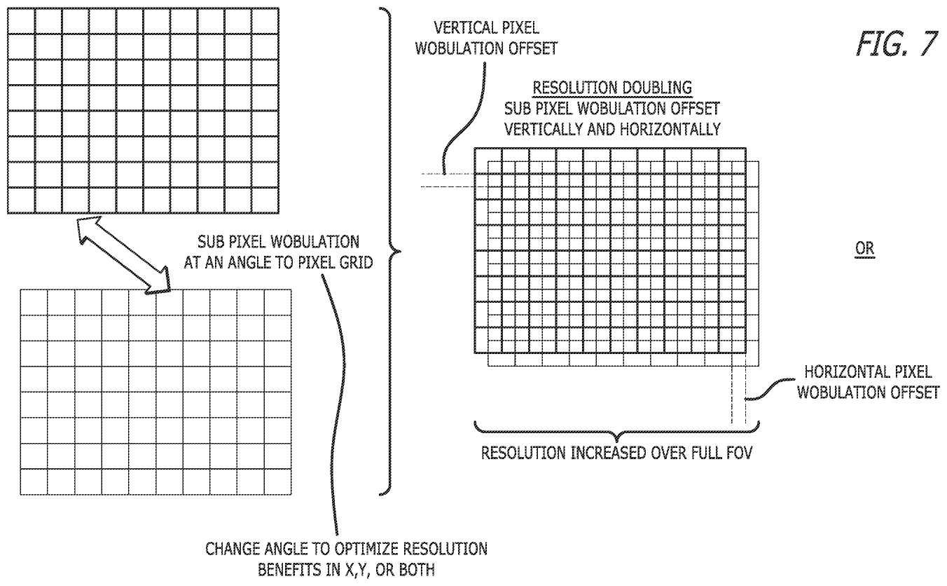

FIG. 7 schematically illustrates the principles of wobulation which may be executed through the waveguide of FIGS. 6A and 6B. The projection of images can occur in a number of different ways in order to produce the best resolution image for the user. For example, as discussed previously, many embodiments can utilize a solid-state resolution enhancement, such as T-Rex as a method to increase the image resolution while being able to minimize weight, cost, and complexity of the design. The T-Rex system can produce multiple angularly displaced versions of an input using switchable gratings disposed in the waveguide thereby avoiding the cost or complexity of implementing equivalent image resolution multiplication within the image generation subsystem. In many embodiments, the projection lenses can collimate and project image modulated light into the waveguide at the native resolution of the image source. As shown in FIG. 7, wobulation is a process by which an image is projected over area field of view multiple times where an offset of the image pixels is generated to create a “wobble” like affect. Ultimately, image wobulation can result in an increased resolution over the full field of view of the user. The increased resolution can apply horizontally, vertically or in both vertically and horizontally across the full FOV. As can be appreciated, many embodiments described herein can use any number of techniques, such as T-Rex to produce the best resolution image without impacting the usability of the wearable display. Accordingly, having a light weight design can improve the overall function of the display by increasing the battery life as well as allowing users to wear the display for longer periods of time.

### Waveguide Displays

Waveguide displays can be used in many different applications, including but not limited to HMDs for AR and VR, helmet mounted displays, projection displays, heads up displays (HUDs), Heads Down Displays, (HDDs), autostereoscopic displays, and wearable displays as illustrated herein. Additionally, similar technology can be applied in waveguide sensors such as, for example, eye trackers, fingerprint scanners and LIDAR systems. Waveguide manufacturing, and especially color waveguide manufacturing, can be expensive and prone to low yield due to several factors. One such contributory influence is the difficulty in aligning separate red, green, blue waveguide layers needed in a full color display. This can be mitigated to a significant extent by reducing the number of waveguide layers used to implement full color. For example, a full color waveguide display can be implemented using two waveguide layers, one transmitting blue-green and the other green-red. Ideally, the display should have as low a number of waveguide layers as possible. However, a single configuration of Bragg gratings typically cannot operate efficiently over the full visual spectral bandwidth. Hence, implementing a full color display using a single grating layer can be challenging. As such, many embodiments of the invention are directed towards utilizing different configurations of gratings within a single grating layer to implement full color waveguides capable of providing two-dimensional beam expansion and light extraction.

In many embodiments, a waveguide display is implemented to include a waveguide having a single grating layer. The waveguide display can further include a source of data-modulated light optically coupled to the waveguide, a first input coupler for directing a first spectral band of light from the source into a first waveguide pupil, and a second input coupler for directing a second spectral band of light from the source into a second waveguide pupil. The source of light can include at least one of an LED or a laser. In some embodiments, the source includes separate red, green, and blue emitters. In several embodiments, the waveguide display includes an output coupler having multiplexed first and second gratings, at least one-fold grating for directing the first spectral band along a first path from the first pupil to the output coupler, and at least one-fold grating for directing the second spectral band along a second path from the second pupil to the output coupler. These fold gratings can be configured to provide a first beam expansion for their respective spectral band. With regards to the output coupler, the first multiplexed grating can be configured to direct the first spectral band out of the waveguide in a first direction with beam expansion orthogonal to the first beam expansion, and the second multiplexed grating can be configured to direct the second spectral band out of the waveguide in the first direction with beam expansion orthogonal to the first beam expansion.

Waveguide displays in accordance with various embodiments of the invention can be implemented and configured in many different ways. In some embodiments, a waveguide display is implemented as a dual-axis beam expansion waveguide that is curved. Additionally, waveguide displays can be made from any number of different materials such as photopolymers and high index light weight plastics. The waveguide can be made from multiple layers or single layers such that the best resolution image is produced.

Single layer waveguide displays, color waveguide displays, materials, and related methods of manufacturing are discussed below in further detail.

Waveguide displays in accordance with various embodiments of the invention can be implemented and configured in many different ways. For illustrative and simplification purposes, the general propagation direction discussed throughout this disclosure is from left to right. As can readily be appreciated, waveguide configurations and light propagation directions can be configured accordingly depending on the specific application. The single layer color waveguide architectures described in the present disclosure have several major advantages over multilayer architectures. A first one is that assembly and alignment of multiple layers is not required, leading to improved yield and lower manufacturing cost. A second advantage is reduced fabrication complexity due to only a single layer being required during fabrication using a single exposure process. This leads to a reduction in exposure throughput time and hence reduced cost. The principles of the invention can be applied to a variety of waveguide display and sensor applications, including but not limited to HUDs and HMDs. Although the invention addresses single layer color waveguides, many of the embodiments and teachings disclosed herein can also be applied to monochrome waveguides.

In many embodiments, a waveguide display can include a source of light, input couplers, and output couplers. Input couplers can include at least one of a prism and input grating. In several embodiments, the output couplers are implemented using output gratings. In further embodiments, the waveguide display can include fold gratings. In several embodiments, each of the fold gratings is configured to provide pupil expansion in a first direction and to direct the light to the output grating via total internal reflection, wherein the output grating is configured to provide pupil expansion in a second direction that is different from the first direction, according to the embodiments and teachings disclosed in the cited references. By using the fold grating, the waveguide device advantageously requires fewer layers than previous systems and methods of displaying information according to some embodiments. In addition, by using the fold grating, light can travel by total internal refection within the waveguide in a single rectangular prism defined by the waveguide outer surfaces while achieving dual pupil expansion.

In many embodiments, at least one of the input, fold, or output gratings can combine two or more angular diffraction prescriptions to expand the angular bandwidth. Similarly, in some embodiments at least one of the input, fold, or output gratings can combine two or more spectral diffraction prescriptions to expand the spectral bandwidth. For example, a color multiplexed grating can be used to diffract two or more of the primary colors.

In several embodiments, the grating layer includes a number of pieces including the input coupler, the fold grating, and the output grating (or portions thereof) that are laminated together to form a single substrate waveguide. The pieces can be separated by optical glue or other transparent material of refractive index matching that of the pieces. In some embodiments, the grating layer can be formed via a cell making process by creating cells of the desired grating thickness and vacuum filling each cell with SBG material for each of the input coupler, the fold grating, and the output grating. In many embodiments, the cell is formed by positioning multiple plates of glass with gaps between the plates of glass that define the desired grating thickness for the input coupler, the fold grating, and the output grating. In several embodiments, one cell can be made with multiple apertures such that the separate apertures are filled with different pockets of SBG material. Any intervening spaces can then be separated by a separating material (e.g., glue, oil, etc.) to define separate areas. In some embodiments, the SBG material can be spin-coated onto a substrate and then covered by a second substrate after curing of the material.

In many embodiments directed towards display applications, the fold grating can be oriented (clocked) with its grating vector in a diagonal direction within the waveguide plane. This ensures adequate angular bandwidth for the folded light. However, some embodiments of the invention can utilize other clock angles to satisfy spatial constraints on the positioning of the gratings that can arise in the ergonomic design of the display. The grating vector orientation angle can be referred to as the “clock angle”. In some embodiments, a longitudinal edge of each fold grating is oblique to the axis of alignment of the input coupler such that each fold grating is set on a diagonal with respect to the direction of propagation of the display light. The fold grating is angled such that light from the input coupler is redirected to the output grating. In one example, the fold grating is set at a forty-five-degree angle relative to the direction that the display image is released from the input coupler. This feature can cause the display image propagating down the fold grating to be turned into the output grating. For example, in several embodiments, the fold grating causes the image to be turned 90 degrees into the output grating. In this manner, a single waveguide can provide dual axis pupil expansion in both the horizontal and vertical directions. In a number of embodiments, each of the fold gratings can have a partially diffractive structure. The output grating receives the image light from the fold grating via total internal reflection and provides pupil expansion in a second direction. The output grating can be configured to provide pupil expansion in a second direction different from the first direction and to cause the light to exit the waveguide from the first surface or the second surface.

In many embodiments, the fold grating angular bandwidth can be enhanced by designing the grating prescription to facilitate dual interaction of the guided light with the grating. Exemplary embodiments of dual interaction fold gratings are disclosed in U.S. patent application Ser. No. 14/620,969 entitled “WAVEGUIDE GRATING DEVICE” the disclosure of which is incorporated herein by reference. In some embodiments, waveguides based on the principles discussed above operate in the infrared band. In some embodiments, at least one of the input, fold or output gratings can be based on surface relief structures.

As discussed above, waveguide displays in accordance with various embodiments of the invention can include a source of light. In some embodiments, the source of data modulated light used with the above waveguide embodiments is configured within an Input Image Node (IIN) incorporating a microdisplay. The input grating can be configured to receive collimated light from the IIN and to cause the light to travel within the waveguide via total internal reflection between the first surface and the second surface to the fold grating. Typically, the IIN integrates in addition to the microdisplay panel, a light source and optical components needed to illuminate the display panel, separate the reflected light, and collimate it into the required FOV. Each image pixel on the microdisplay can be converted into a unique angular direction within the first waveguide. Any of a variety of microdisplay technologies can be utilized. In some embodiments, the microdisplay panel can be a liquid crystal device or a Micro Electro Mechanical System (MEMS) device. In several embodiments, the microdisplay can be based on Organic Light Emitting Diode (OLED) technology. Such emissive devices would typically not require a separate light source and would therefore offer the benefits of a smaller form factor. In a number of embodiments, the IIN can be based on a scanned modulated laser. The IIN projects the image displayed on the microdisplay panel into collimated beam directions such that each display pixel is converted into a unique angular direction within the substrate waveguide according to some embodiments. The collimation optics (which is often referred to as the projection lens) contained in the IIN can include lenses and mirrors, which can be diffractive lenses and mirrors. In some embodiments, the IIN can be based on the embodiments and teachings disclosed in U.S. patent application Ser. No. 13/869,866 entitled “HOLOGRAPHIC WIDE ANGLE DISPLAY,” and U.S. patent application Ser. No. 13/844,456 entitled “TRANSPARENT WAVEGUIDE DISPLAY”, the disclosures of which are incorporated herein by reference. In several embodiments, the IIN contains a beamsplitter for directing light onto the microdisplay and transmitting the reflected light towards the waveguide. In a number of embodiments, the beamsplitter is a grating recorded in HPDLC and uses the intrinsic polarization selectivity of such gratings to separate the light illuminating the display and the image modulated light reflected off the display. In some embodiments, the beam splitter is a polarizing beam splitter cube. In many embodiments, a grating beamsplitter may make used of the polarization selectivity of a grating to transmit light reflected of the display without substantially altering its direction, intensity or polarization state. In many embodiments, a grating beamsplitter may make used of the Bragg diffraction efficiency angular bandwidth selectivity of a grating to transmit off-Bragg light reflected of the display without substantially altering its direction, intensity or polarization state.

In many embodiments, the IIN incorporates a despeckler. Advantageously, the despeckler is holographic waveguide device based on the embodiments and teachings of U.S. Pat. No. 8,565,560 entitled “LASER ILLUMINATION DEVICE”, the disclosure of which is incorporated herein by reference. The light source can be a laser or LED and can include one or more lenses for modifying the illumination beam angular characteristics. The use of a despeckler is particularly important where the source is a laser and the image source is a laser-lit microdisplay or a laser-based emissive display. LED will provide better uniformity than laser. If laser illumination is used, there is a risk of illumination banding occurring at the waveguide output. In some embodiments, laser illumination banding in waveguides can be overcome using the techniques and teachings disclosed in U.S. Provisional Patent Application No. 62/071,277 entitled “METHOD AND APPARATUS FOR GENERATING INPUT IMAGES FOR HOLOGRAPHIC WAVEGUIDE DISPLAYS”, the disclosure of which is incorporated herein by reference. In several embodiments, the light from the light source is polarized. In some embodiments, an incoherent light source may be used in which illumination homogenization may be used. Various components and methods for illumination homogenization are discussed in U.S. Pat. No. 8,565,560 which is hereby incorporated by reference for all purposes in its entirety. In a number of embodiments, the image source is a liquid crystal display (LCD) micro display or liquid crystal on silicon (LCoS) micro display.

In many embodiments, the waveguide display includes first and second input couplers. The first and second input couplers can each include at least one of a prism and a grating. In some embodiments, the couplers utilize a single prism and are respectively associated with a pair of first and second input gratings, the first and second input gratings being disposed along the general light propagation direction of the waveguide. In several embodiments, the first and second gratings are disposed along a direction orthogonal to the general light propagation direction of the waveguide. The first and second input gratings can be implemented in the waveguide and configured in many different ways. In a number of embodiments, the input gratings are spatially separated. In other embodiments, the input gratings are implemented as multiplexed gratings. In many embodiments, multiplexed input gratings can multiplex gratings operating at different wavelengths. In many embodiments, multiplexed input gratings can multiplex gratings operating over different angular ranges. In many embodiments, multiplexed input gratings can multiplex gratings clocked at different angles. For example, the input gratings of FIG. 6B could be implements as multiplexed gratings in some embodiments. In many embodiments, multiplexed input gratings can multiplex gratings with different k-vectors. The crossed configuration of the multiplexed gratings can be advantageous for gratings recorded in HPDLC materials since it can enable efficient phase separation of liquid crystal and monomer components during the recording of the grating.

In some embodiments directed at displays using unpolarized light sources, the input gratings used can combine gratings orientated such that each grating diffracts a particular polarization of the incident unpolarized light into a waveguide path. Such embodiments may incorporate some of the embodiments and teachings disclosed in the PCT application PCT/GB2017/000040 “METHOD AND APPARATUS FOR PROVIDING A POLARIZATION SELECTIVE HOLOGRAPHIC WAVEGUIDE DEVICE” by Waldern et al., the disclosure of which is incorporated herein by reference in its entirety. The output gratings can be configured in a similar fashion such that the light from the waveguide paths is combined and coupled out of the waveguide as unpolarized light. For example, in some embodiments the input grating and output grating each combine crossed gratings with peak diffraction efficiency for orthogonal polarizations states. In several embodiments, the polarization states are S-polarized and P-polarized. In a number of embodiments, the polarization states are opposing senses of circular polarization. The advantage of gratings recorded in liquid crystal polymer systems, such as but not limited to SBGs, in this regard is that owing to their inherent birefringence, they can exhibit strong polarization selectivity. However, other grating technologies that can be configured to provide unique polarization states can also be used.

In embodiments utilizing gratings recorded in liquid crystal polymer material systems, at least one polarization control layer overlapping at least one of the fold gratings, input gratings, or output gratings can be provided for the purposes of compensating for polarization rotation in any of the gratings, particularly the fold gratings. In many embodiments, all of the gratings are overlaid by polarization control layers. In some embodiments, polarization control layers are applied only to a subset of the gratings, such as only to the fold gratings. The polarization control layer can include an optical retarder film. In several embodiments based on HPDLC materials, the birefringence of the gratings can be used to control the polarization properties of the waveguide device. The use of the birefringence tensor of the HPDLC grating, K-vectors, and grating footprints as design variables opens up the design space for optimizing the angular capability and optical efficiency of the waveguide device. In some embodiments, a quarter wave plate disposed on a glass-air interface of the waveguide rotates the polarization of a light ray to maintain efficient coupling with the gratings. For example, in one embodiment, the quarter wave plate is a coating that is applied to a substrate of the waveguide. In some waveguide display embodiments, applying a quarter wave coating to a substrate of the waveguide can help light rays retain alignment with the intended viewing axis by compensating for skew waves in the waveguide. In a number of embodiments, the quarter wave plate can be provided as multi-layer coating.

In many embodiments, the waveguide display is implemented to provide an image at infinity. In some embodiments, the image can be at some intermediate distance. In several embodiments, the image can be at a distance compatible with the relaxed viewing range of the human eye. For example, many waveguides in accordance with various embodiments of the invention can cover viewing ranges from about 2 meters up to about 10 meters.

### Switchable Bragg Gratings

Optical structures recorded in waveguides can include many different types of optical elements, such as but not limited to diffraction gratings. In many embodiments, the grating implemented is a Bragg grating (also referred to as a volume grating). Bragg gratings can have high efficiency with little light being diffracted into higher orders. The relative amount of light in the diffracted and zero order can be varied by controlling the refractive index modulation of the grating; a property that is can be used to make lossy waveguide gratings for extracting light over a large pupil. One class of gratings used in holographic waveguide devices is the Switchable Bragg Grating (“SBG”). SBGs can be fabricated by first placing a thin film of a mixture of photopolymerizable monomers and liquid crystal material between glass plates or substrates. In many cases, the glass plates are in a parallel configuration. One or both glass plates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets. In some embodiments, the grating in a given layer is recorded in stepwise fashion by scanning or stepping the recording laser beams across the grating area. In several embodiments, the gratings are recorded using mastering and contact copying process currently used in the holographic printing industry.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (“ITO”). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 μs with a longer relaxation time to switch ON. Note that the diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The glass plates used to form the HPDLC cell provide a total internal reflection (“TIR”) light guiding structure. Light can be coupled out of the SBG when the switchable grating diffracts the light at an angle beyond the TIR condition.

In many embodiments, SBGs are recorded in a uniform modulation material, such as POLICRYPS or POLIPHEM forming continuous liquid crystal regions separated by polymer regions. Exemplary uniform modulation liquid crystal-polymer material systems are disclosed in United State Patent Application Publication No.: US2007/0019152 by Caputo et al and PCT Application No.: PCT/EP2005/006950 by Stumpe et al. both of which are incorporated herein by reference in their entireties. Uniform modulation gratings are characterized by high refractive index modulation (and hence high diffraction efficiency) and low scatter. In some embodiments, at least one of the gratings is recorded a reverse mode HPDLC material. Reverse mode HPDLC differs from conventional HPDLC in that the grating is passive when no electric field is applied and becomes diffractive in the presence of an electric field. The reverse mode HPDLC may be based on any of the recipes and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES, the disclosure of which is incorporated herein by reference.

### DOCTRINE OF EQUIVALENTS

While the above description contains many specific embodiments of the invention, these should not be construed as limitations on the scope of the invention, but rather as an example of one embodiment thereof. Although only a few embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A waveguide display comprising:
a first microLED array emitting a first wavelength image-containing light;
a second microLED array emitting a second wavelength image-containing light;
a first projection lens for collimating and projecting the first wavelength image-containing light over a field of view;
a second projection lens for collimating and projecting the second wavelength image-containing light over a field of view;
a waveguide supporting:
an output grating configured to provide light extraction from the waveguide;
a first input coupler for directing the first wavelength image-containing light into a first TIR path within the waveguide via a first pupil; and
a second input coupler for directing the second wavelength image-containing light into a second TIR path within the waveguide via a second pupil.

2. The waveguide display of claim 1, wherein the waveguide is curved.

3. The waveguide display of claim 1, further comprising a third microLED array emitting third wavelength image-containing light; a third projection lens for collimating and projecting the third wavelength image-containing light over a field of view; and a third input coupler for directing the third wavelength image-containing light into a third TIR path within the waveguide via a third pupil.

4. The waveguide display of claim 3, wherein the first, second, and third wavelengths correspond to red, green, and blue light respectively.

5. The waveguide display of claim 3, wherein the first, second and third microLEDs are disposed adjacent to each other along the waveguide beam propagation direction.

6. The waveguide display of claim 1, wherein the waveguide further comprises gratings configured to multiply the resolution of the image.

7. The waveguide display of claim 1, further comprising polarization selecting and polarization rotating optical elements disposed in the optical path between each microLED array and the waveguide for converting the light from each microLED array into polarized light.

8. The waveguide display of claim 1, wherein the waveguide has a substrate curvature providing a spectacle prescription.

9. The waveguide display of claim 1, wherein the waveguide, the first microLED array, the second microLED array, the first projection lens, and second projection lens are integrated within a spectacle frame.

10. The waveguide display of claim 1, further comprising at least one selected from the group consisting of: a camera, a LiPo battery, a microphone, a spatial audio module, a radio, a microprocessor, plastic or thixotropic molded magnesium hinges, a heat path sink formed from graphene or aluminum, and carbon fiber components used for RF emission and SAR protection.

11. The waveguide display of claim 1, wherein the output grating multiplexes a grating for diffracting first wavelength light and a grating for diffracting second wavelength light.

12. The waveguide display of claim 1, wherein the output grating multiplexes a first grating for diffracting light in first angular range and a second grating for diffracting light in a second angular range.

13. The waveguide display of claim 1, wherein the output grating performs a beam expansion.

14. The waveguide display of claim 13, further comprising a first fold grating and a second fold grating, wherein the first fold grating provides a beam expansion in a first direction, wherein the second fold grating provides a beam expansion in the first direction, wherein the first direction is orthogonal to the beam expansion direction of the output grating.

15. The waveguide display of claim 13, further comprising a first fold grating for directing first wavelength image-containing light in the first TIR path towards the output grating and a second fold grating for directing second wavelength image-containing light in the second TIR path towards the output grating, wherein the output grating is configured to direct the first wavelength light and the second wavelength light into a common extraction direction.

16. The waveguide display of claim 1, wherein the output grating performs both one-dimensional beam expansion and extraction of light from the waveguide.

17. The waveguide display of claim 1, wherein the first input coupler and the second input coupler each comprise multiple stacked switchable gratings which input light into two different TIR paths angularly displaced by an angle equivalent to half a pixel of the input image in at least one of horizontal direction or vertical direction.

18. The waveguide display of claim 1, wherein the output grating comprises a passive grating configured to output light from the first TIR path and the second TIR path.

19. The waveguide display of claim 18, wherein the output light from the first TIR path and the second TIR path, when combined, has double the resolution of the light input into the waveguide in at least one of the horizontal and vertical directions.

20. The waveguide display of claim 1, wherein at least one of the output grating, the first input grating, or the second input grating comprises a holographic polymer dispersed liquid crystal (“HPDLC”) grating.

21. The waveguide display of claim 1, wherein at least one of the output grating, the first input grating, or the second input grating comprises an evacuated Bragg grating (EBG).

22. The waveguide display of claim 1, wherein the first input grating is physically spaced apart from the second input grating.

23. The waveguide display of claim 1, wherein the first projection lens and the second projection lens project light towards separate locations on the waveguide.

24. The waveguide display of claim 1, further comprising switchable gratings configured for output field of view tiling.

25. The waveguide display of claim 1, wherein the output grating comprises a first switchable grating configured to provide extraction of a first field of view portion from the waveguide and a second switchable grating configured to provide extraction of a second field of view portion from the waveguide;
wherein the first input coupler comprises a third switchable grating for directing the first wavelength image-containing light in the first field of view portion into a TIR path towards the output grating via the first pupil and a fourth switchable grating for directing the first wavelength image-containing light in the second field of view portion into a TIR path towards the output grating via the first pupil;
wherein the second input coupler comprises a fifth switchable grating for directing the second wavelength image-containing light in the first field of view portion into a TIR path towards the output grating via the second pupil and a sixth switchable grating for directing the second wavelength image-containing light in the second field of view portion into a TIR path towards the output grating via the second pupil; and
wherein the first switchable grating, the third switchable grating, and the fifth grating are in their diffracting states when a first field of view tile data is displayed on the first microLED array and the second microLED array, and the second switchable grating, fourth switchable grating, and the sixth switchable grating are in their diffracting states when a second field of view tile data is displayed on the first microLED array and the second microLED array.

26. A waveguide display comprising:
a first microLED array emitting a first wavelength image-containing light;
a second microLED array emitting a second wavelength image-containing light;
a first projection lens for collimating and projecting the first wavelength image-containing light over a field of view;
a second projection lens for collimating and projecting the second wavelength image-containing light over a field of view;
a waveguide supporting:
a first fold grating and a second fold grating configured in a stack or multiplexed in a layer, wherein the first fold grating and second fold grating perform two-dimensional beam expansion and extraction of light from the waveguide;
an output grating configured to provide light extraction from the waveguide;
a first input coupler for directing the first wavelength image-containing light into a first TIR path within the waveguide via a first pupil; and
a second input coupler for directing the second wavelength image-containing light into a second TIR path within the waveguide via a second pupil.
